(19) United States
(12) Patent Application Publication
(10) Pub. No.: US 2026/0112891 A1
(43) Pub. Date: Apr. 23, 2026

(54) DYNAMIC POWER BALANCING ARCHITECTURE AMONG SEAT GROUP LINE REPLACEABLE UNITS

(71) Applicant: Panasonic Avionics Corporation, Irvine, CA (US)

(72) Inventors: Christopher LYLE, Trabuco Canyon, CA (US); Konstantin LAZAREV, Anaheim, CA (US); Nirav PATEL, Fullerton, CA (US); Yichao JIANG, Irvine, CA (US); Ian ANDAL, Anaheim, CA (US); Huian DONG, Irvine, CA (US); Wang NG, Chino Hills, CA (US)

(21) Appl. No.: 19/056,526

(22) Filed: Feb. 18, 2025

Related U.S. Application Data
(60) Provisional application No. 63/711,093, filed on Oct. 23, 2024.

(51) Int. Cl. H02J 3/02; B64D 11/06; H02J 3/00; H02J 3/14

(52) U.S. Cl. CPC H02J 3/02; B64D 11/0624; H02J 3/001; H02J 3/17; B64D 2221/00; H02J 2105/32

(57) ABSTRACT

A power supply system for use in an airplane is described. The power supply system includes N alternating current (AC) power outlets configured to provide AC power output at a passenger seat in an airplane, M direct current (DC) power outlets configured to provide DC power output at the passenger seat and a controller configured to control allocation of power from a power supply to the N AC power outlets and M DC power outlet according to a phase of a plurality of phases of operation of the power supply system, where N and M are positive integers.

### CROSS-REFERENCE TO RELATED APPLICATION(S)

This application claims the benefit of priority of U.S. Provisional Patent Application No. 63/711,093, filed Oct. 23, 2024. The content of the foregoing application is incorporated herein in its entirety by reference.

### TECHNICAL FIELD

This application is related to the operation of an in-flight entertainment system.

### BACKGROUND

Commercial travel has evolved to provide entertainment options to passengers traveling to their destinations. For example, in an airplane or train, entertainment options are provided on monitors located on the back of seats, where the monitors can enable passengers to watch movies or television shows as they travel to their destinations. Passenger vehicles have also begun to provide connectivity tools that may provide additional opportunities to passengers for entertainment or productivity.

### SUMMARY

The present document provides various techniques that may be used to manage power supplied to passengers of commercial passenger vehicles.

In one example aspect, a power supply system is disclosed. The system includes N alternating current (AC) power outlets configured to provide AC power output at a passenger seat in an airplane, M direct current (DC) power outlets configured to provide DC power output at the passenger seat, and a controller configured to control allocation of power from a power supply to the N AC power outlets and M DC power outlet according to a phase of K phases of operation of the power supply system, where K, N and M are positive integers and K is greater than 1.

In another example aspect, a method of operating an electronic equipment is disclosed. The method includes providing a chassis on an aircraft, wherein the chassis includes at least one chassis processor, wherein the chassis is configured with N slots for accepting N electronic blades comprising zero or more of compute blades and zero or more of storage blades, where N is a positive integer greater than 1; wherein the at least one chassis processor is configured to provide a common operational interface between multiple types of aircrafts and the N electronic blades, and populating the N slots with compute blades and/or storage blades according to a target configuration.

In yet another aspect, an apparatus comprising one or more processors configured to implement the described methods is disclosed.

In yet another aspect, a computer readable medium is disclosed. The computer readable medium stores processor-executable program code that, upon execution by one or more processors, causes implementation of a method described in the present document.

These, and other aspects are disclosed throughout the present document.

### BRIEF DESCRIPTION OF THE DRAWINGS

FIG. 1 shows an exemplary airplane depicting an in-flight entertainment and communications (IFEC) installation.

FIG. 2 shows an example of a system for sensor data collection and analysis.

FIG. 3 is a block diagram of an example of a power control system.

FIG. 4 is a block diagram example of a universal serial bus (USB) power balancing system.

FIG. 5 is a block diagram of power supply scheme for multiple seats in a row.

FIG. 6 is a flowchart depicting an example of a method of operating power supply in an airplane.

FIG. 7 is a block diagram of an example power control system.

### DETAILED DESCRIPTION

The present documents disclose techniques for controlling power distribution to passenger seats in a commercial passenger vehicle. Although airlines embodiments are used for illustrative purposes, the disclosed techniques may be practiced in an airplane or another commercial passenger vehicle such as a train, a cruise ship, a bus, etc.

### 1. Introduction

Among the many advancements in aircraft technology, improvements in passenger comfort and convenience have received much attention. Air travel typically involves journeys over extended distances that at the very least take several hours to complete, so airlines provide onboard IFEC systems that offer a wide variety of multimedia content for passenger enjoyment. Recently released movies are a popular viewing choice, as are television shows such as news programs, situation and stand-up comedies, documentaries, and so on. Useful information about the destination such as airport disembarking procedures, immigration and custom procedures and the like are also frequently presented. Audio-only programming is also available, typically comprised of playlists of songs fitting into a common theme or genre. Likewise, video-only content such as flight progress mapping, flight status displays, and so forth are available. Many in-flight entertainment systems also include video games that may be played by the passenger.

The specific installation may vary depending on service class, though in general, each passenger seat is equipped with a display device, an audio output modality, an input modality, and a terminal unit. The terminal unit may generate video and audio signals, receive inputs from the input modality, and execute pre-programmed instructions in response thereto. The display device is typically an LCD screen that is installed on the seatback of the row in front of the passenger, though in some cases it may be mounted to a bulkhead or retractable arm, or the like, which is in turn mounted to the passenger's seat. Furthermore, the audio output modality is a headphone jack, to which a headphone, either supplied by the airline or by the passenger, may be connected. Inputs to the terminal unit may be provided via a separate multi-function remote controller or by via a combination touch display. Although the terminal unit and display device were separate components in earlier IFEC implementations, more recently, these components and more may be integrated into a single smart monitor.

The multimedia content is encoded and stored as digital data, with a video decoder and audio decoder of the terminal unit functioning to generate the aforementioned video and audio signals therefrom. It is desirable to have a wide range of different multimedia content to satisfy the varying tastes of passengers. It is also desirable to have a sufficient volume of multimedia content so that passengers can remain occupied with entertainment for the entire duration of the flight. Accordingly, the multimedia content stored onboard the aircraft can range in the hundreds of gigabytes, if not over a terabyte. The majority of the data comprises the video programming, although the audio and video game content may be significant as well. This data is typically not stored on each individual terminal unit, but rather, in a central content server also onboard the aircraft. In this regard, the terminal unit is understood to incorporate networking modalities such as Ethernet to establish data communications with the central content server. Once a particular selection of multimedia content is requested by the passenger via the content selection application, the terminal unit may retrieve the same from the central content server, decode the data, and present it to the passenger.

Because the personal tastes and preferences of passengers can vary considerably, airlines maintain a wide range of multimedia content onboard the content server. Furthermore, in addition to variety of volume, novelty is as important for airlines to keep its passengers engaged with the in-flight entertainment system, particularly for valuable frequent fliers. A variety of modalities, including portable content loaders, wireless modules, and the like may be used to load sets of multimedia content to the content server. The content update process typically takes place on a monthly schedule, preferably during a layover between flights, such as when aircraft maintenance is conducted. For each item of multimedia content loaded on to the IFEC system in this way, however, the airlines must pay a fee. Specifically, the charges are based upon the size of the multimedia content set loaded, as well as the number of cycles or intervals over which the multimedia content is maintained on an aircraft. Scaled to an entire fleet of aircraft, these charges may be substantial, and because they are levied against the entire content set that is loaded on the aircraft, airlines are being charged for content that is viewed less frequently and/or not being viewed at all.

Additionally, there is a growing trend to allow passengers to use their personal (or passenger) electronic devices (PEDs) (e.g., smartphone, laptops, or tablets) for entertainment, which allows passengers to minimize having to touch a commonly exposed surface. The audio or video content provided by the IFEC platform to the PED may include movies, television shows, or other content such as advertisements or flight safety video. Each seatback device has an enclosure that can have a processor executing custom software programs to receive messages or commands from an edge server and to display visual content on a display of the seatback device and to output sound to a headphone jack. Conventional in-vehicle entertainment systems can also wirelessly transmit audio or video content to PEDs that belong to passengers.

The above-described passenger amenities and services are provided using an electronic network that includes video servers, wiring, seatback displays, card readers, wireless network equipment, satellite transmission and reception equipment and so on. Deployment and maintenance of this equipment can be expensive, which requires the airlines to pay attention to which electronic systems and services are used by passengers more frequently or longer. Therefore, it is beneficial for airlines to measure and monitor use of various electronic equipment by passengers. For example, one benefit is to ensure passenger satisfaction, which may lead to the passenger preferring to travel on a particular airline. Another benefit is that airlines can find out the electronic systems that are popular and heavily used and may focus their maintenance and replacement resources to ensure that these electronic systems are available to passengers with minimum down time or errors. One problem is the lack of a standard method to quantify or qualify passenger engagement (for example, in the cabin).

### 2. Growing Challenges in Power Distribution

In view of the above discussion about how the nature of in-flight entertainment and passenger expectations are changing, it would be appreciated by those of skill in the art that there is a growing demand for availability of power to charge various passenger electronic devices (PEDs) that may be used by passengers during travel.

Conventional design will dedicate a specific power allocation for alternating current AC and direct current DC charging. When AC is not being used, the power allocated for AC cannot be redirect to DC charging purpose. The same limitation applied to DC. This will cause the power supply design to be large enough to cover both AC and DC use case, although in real life the two kinds of charging usually do not happen at the same time. This will cause unnecessary procurement and operational cost due to there will always be some idle hardware during operation. The present document discloses, among other things, techniques for AC/DC balancing that is based on a shared power allocation. The AC charging and DC charging share the same pool of power. When there is no AC charging, all power can be relocated for DC use. When there is no DC charging, all power can be relocated for AC charging. When AC and DC are both present, a monitoring circuit will constantly monitor the load of AC and divert the remaining power not used by AC to DC charging to maximize the utilization of the power available.

All the change and balancing for AC and DC are happening automatically, under control of a circuit and/or a controller (a processor or a microprocessor). When the AC load reduces due to passenger inactivity or battery fully charged, the power allocation for AC will automatically be reduced in tiered manner and surplus power is redirected to DC. It does not require customer to repeated plug/unplug devices to trigger. When AC load increases, the monitoring circuit also automatically relocate power from DC charging to AC charging pool.

### 3. Exemplary Computing System and IFEC deployments

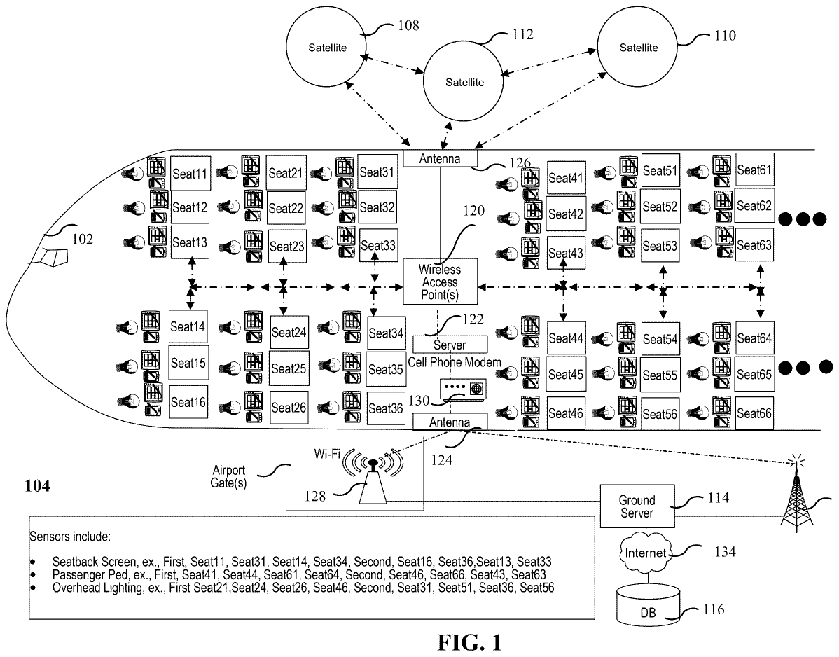

FIG. 1 shows an example system in which the various power balancing techniques described in the present document may be implemented. An airplane 102 is depicted to include multiple passenger seats, Seat11 to Seat 66. The airplane 102 may include an antenna 126 that is configured to communicate with external communication sources such as a satellite network that includes one or more satellites 108, 110, 112. Satellite communication may be used for both downloading information and uploading information. Wi-Fi 128 at airport gate(s) and Cell-phone modem 130 through a Cell Phone Tower 132 may be used to both downloading information and uploading information from/to ground server 114 through the Internet 134 and from/to database 116 as illustrated most notably in FIG. 1.

The airplane 102 may include an onboard server 122, one or more wireless access points 120 and an antenna 124 that is configured for communication with a ground server 114 that includes a database 116.

Also shown in FIG. 1 is an example of a script 104 that is used for collecting sensor data on the airplane 102. The script 104 may include a list of entries that show zones where sensor data, e.g., raw intrinsic data, raw extrinsic data, raw global data, is collected and ordered. For example, the first entry shows that seats 11, 31, 14, 34 are to be first, followed by seats 16, 36, 13 and 33, and so on. Corresponding to each entry, there may be an onboard electronic device on passengers may be alerted for collecting sensor data from a sensor network, for example, including Seatback Display (illustrated by screen icon), Passenger PED (illustrated by mobile device icon), and Overhead Lighting (illustrated by light bulb icon).

For example, for the above-listed seats, a message may be displayed on a seatback screen. For the next entry (corresponding to seats 41, 33, 61 and 64) a message may be sent to passengers' personal electronic devices (PEDs) for data sensor collection instructions, e.g., take a survey or complete a questionnaire, and/or as scripted for the sensor data collected by the sensor network about passengers about one or more aspects or incidents (e.g., when, during, what, before, during or at end one or more flights or destinations, number or quantity of or time of or time duration) in their trip, e.g., watching movies, browsing selected live television programs, sports casts, preferences for food, drink, and snack selections, cleanliness of the airplane, crew availability or helpfulness or resolving issues, informativeness of captain about flight and status to destination, and politeness and promptness of aircraft attendants. In one example, as illustrated in FIG. 1, seats 11, 31, 14, 34 (first) and seats 16, 36, 13, and 33 (second) are scripted as passengers for collecting sensor data from the sensor network, e.g., before flight, after flight at designated intervals or upon certain events (e.g., when, during, what, before, during or at end one or more flights or destinations, number or quantity of or time of or time duration), e.g., calling attendant, ordering food, ordering movies, surfing the Internet, using or clicking features of the Seatback Display, and before, during, or upon deplaning. Seats 41, 44, 61, 64 (first) and seats 46, 66, 43, 63 (second) are scripted as passengers for collecting sensor data from the sensor network before flight, after flight at designated intervals or upon certain events (e.g., when, during, what, before, during or at end one or more flights or destinations, number or quantity of or time of or time duration), and during deplaning. Seats 21, 24, 26, 46 (first) and seats 31, 51, 36, 56 (second) are scripted as passengers for collecting sensor data from the sensor network (e.g., when, during, what, before, during or at end one or more flights or destinations, number or quantity of or time of or time duration) before flight, after flight at designated intervals, and during deplaning.

Continuing with FIG. 1, in some embodiments, passengers, individual passenger(s), and/or group(s) of passengers, and/or airline personnel can each select one or more modes for collecting sensor data, e.g., Seatback Screen, overhead lighting, Passenger PED, for example, by entry into to a Seatback Screen, a passenger manifest, or an airline companion app downloaded on a mobile device (a Passenger PED) of a passenger. In some embodiments, passengers and/or individual passenger(s) and/or group(s) of passengers are selected for collecting sensor data in accordance with one or more screening criteria, e.g., when, how often, how, . . . or combinations thereof including: location of origin for flight, location of destination of flight, location of layover flight, news or history of events at origin, destination, or layover flight, monitor passenger health status during flight, traveling together family members, traveling together friends, business partners, and/or any other methods or systems described above or below, adjustments for collecting sensor data, when, how, how much, how often or ordering, for example, physical separation or time gap(s) between passenger seats (as illustrated in FIG. 1), any empty seats or rows, or the like. In FIG. 1, the server 122 may be implemented by one or more processors. The server 122 may implement the script described in the present document. The wireless access points 120 may be used for prompting PEDs via messages to deplane. In some embodiments, the wireless access points 120 may be used for detecting PEDs based on signal quality (e.g., signal strength) and this information may be used to determine travel configuration of the airplane during flight. The antenna 124 may be used for communication between the ground server 114 and the server 122. The ground server 114 may provide the server 122 with passenger information, or passenger manifest, prior to the departure of the flight. The ground server 114 may also provide additional information about passenger such as passenger's previous flight history or other social activities such that prior passenger engagements with IFEC tracing can be performed.

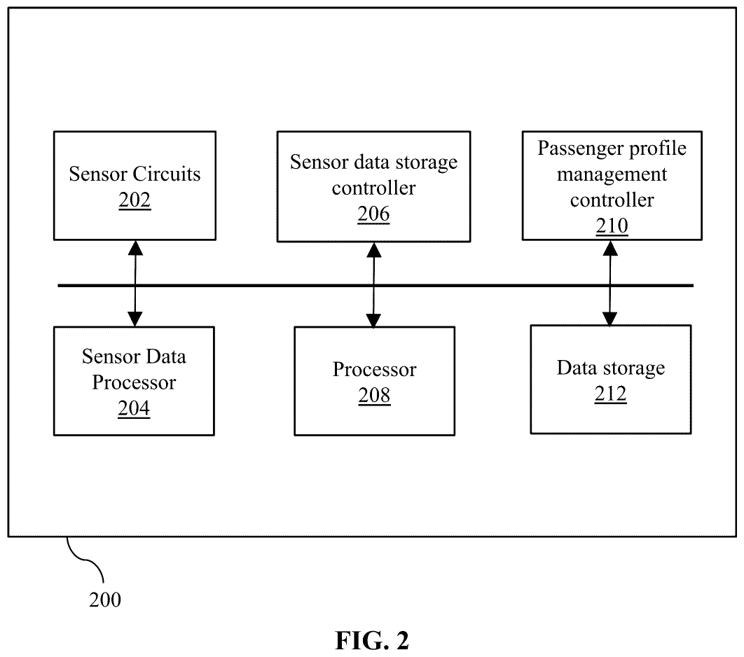

FIG. 2 is a block diagram of some functional blocks of an IFEC system 200 onboard an airplane. The IFEC system 200 includes the following. Sensor circuits 202 configured to received passenger inputs, including touch, vision, and communication signal inputs. Sensor data processor 204 that is configured to make action decisions based on the received sensor inputs. A sensor data storage controller 206 that may store various passenger interactions. One or more processors 208 that may orchestrate passenger interactions with resources outside the airplane (e.g., internet based service providers). Passenger profile management controller 210 may be used to detect passenger identities and provide power and other services to them according to their preferences. Data storage 212 may be used to store data used for implementation of various techniques described herein.

### 4. Example Embodiments of Power Balancing

### 4.1. Examples of Customer Experience

The DC and AC power sharing is transparent as possible to the customer to minimize power cut off to load. In some embodiments, if there is a power demand conflict between AC and DC, AC is set as priority.

Typically, AC load has no negotiation or power limit on the load. AC power will be set as priority to maintain continuous AC power to the customer.
1. 3 levels of AC profile may be included, e.g., 50 W-100 W-150 W (the actual values of number of levels and wattage level may be different).
2. 2 levels of warning threshold is used as trigger point for Ramp-up/down. 50 W Warning=33 W. 100 W Warning=65 W.
3. Example, 27 W phone charger on the AC outlet will be assigned 50 W AC budget after monitoring and balancing.

In some embodiments, DC power will be reduced to 4.5 W only during initial AC plug in or AC load ramp up.
1. Low power devices such as phones will be able to continue charge with 4.5 W.
2. Non-Power Delivery (PD) charging devices are not affected as their charging power is always 4.5 W
3. Non-charging devices such as headphone is not affected as 4.5 W is not removed.
4. Laptop will likely stop charging after balancing is complete sometime later.
   1. The Product Line Management (PLM) has agreed that certain devices may not be able to charge as acceptable results.
   2. If AC load requires full 150 W and there is insufficient DC power remaining, best effort DC balancing will be provided to all DC sinks.

### 4.2. 1st Stage AC/DC Balancing Examples

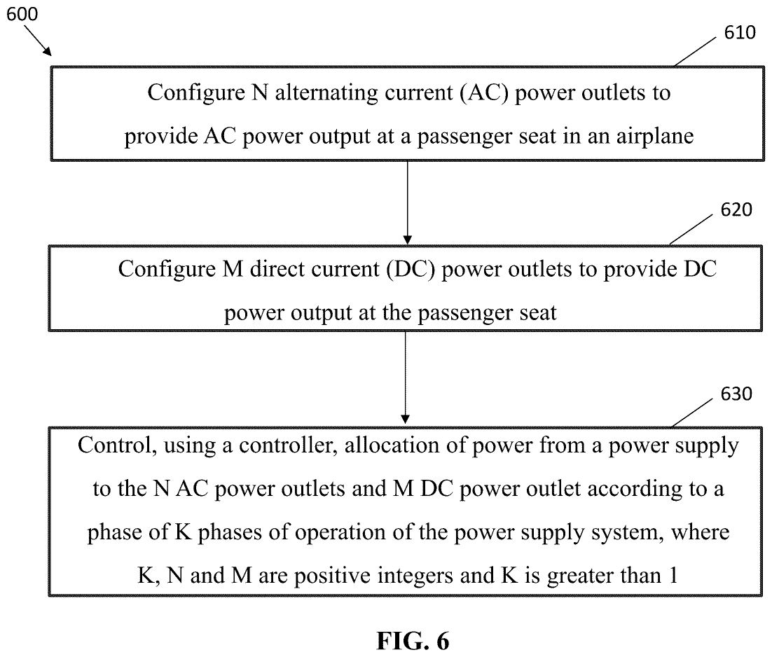

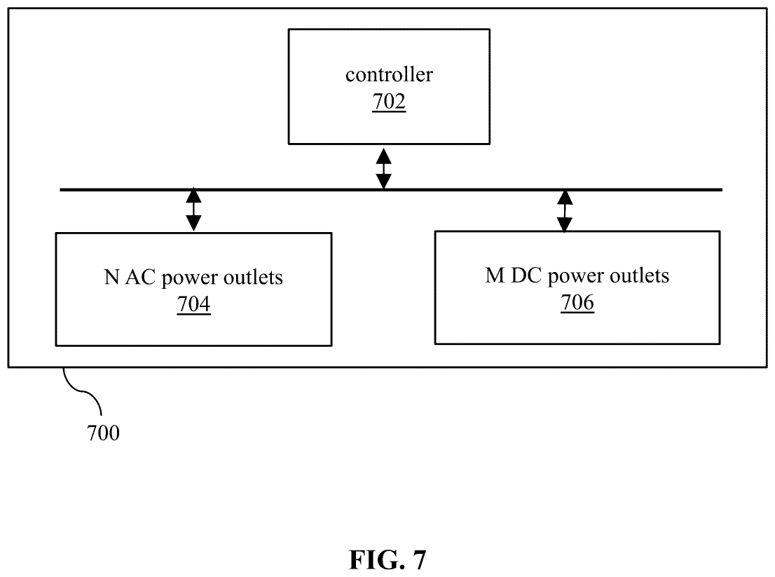

1. The PED power budget for USB and AC power is calculated during Acceptance Test Procedure (ATP) (based on peripheral power requirements) and provided as a database config item.
2. AC inverter is off, and the AC power budget is 0 W while an AC PED is not attached.
3. The USB power budget=the PED power budget−AC power budget
4. USB port power is balanced based on the USB power budget and a design (refer to FIGS. 6 and 7).

4.2.1 Plug in Case. When a passenger attaches an AC PED, the following occurs:
1. The USB port power reduces to 4.5 W for each passenger facing port (type A and type C)
2. The AC inverter is enabled and provides AC power to the PED.
3. Hardware/firmware measures the current provided to the AC PED (likely on the DC input to the AC inverter)
4. Once a stable current reading is made (this could be the ceiling value or where the value settles after a few seconds), the AC power budget is updated.
5. USB power budget is updated (reduced by the AC power budget)
6. USB port power can be rebalanced using the updated budget.

4.2.2 Ramp-Down Case. When a passenger got assigned a higher AC power budget, but later the load consumption drops below the warning threshold of lower tier.
1. The Microcontroller Unit (MCU) in SEATBOX continues to poll the Power Monitor (PMON) circuit in a loop.
   1. Samples can be stored in a buffer with a series of polled sample values
2. MCU's internal algorithm calculate the long term average of the load. If the calculated value is consistently below the warning threshold of previous tier. Ramp down sequence can start.
   1. High noise rejection filter such as moving average window can be used to calculate the average of the sequence of sample values.
   2. Multiple average calculations can be used before a Ramp-down decision is made.
   3. “Time off” mechanism can also be implemented to avoid repeatedly switching between tiers. Such as X minutes must pass after a Ramp-up before Ramp-down is allowed.
3. After Ramp-down is triggered in MCU in seatbox. MCU sets the new current limit value to the warning threshold of the lower power tier.
4. MCU in SEATBOX notifies the System on Module (SOM) on additional power available due to reduced AC power allocation.
5. MCU continues to poll PMON (power monitoring) circuit for future Ramp-up or Ramp-down event if the conditions are met.
6. USB power budget is updated.
7. USB port power can be rebalanced using the updated budget.

4.2.3 Ramp-Up Case. When a passenger got assigned a lower AC power budget, but later the load consumption increases above the warning threshold of the higher tier.
1. MCU in SEATBOX continues to poll the PMON circuit. One sample exceeds the warning threshold of the current level. One interrupt from PMON circuitry is generated to the MCU.
2. MCU in SEATBOX sends out the pre-coded Layer 2 Ethernet Messaging (L2) frame to all charging peripherals managed by an MCU (Receiver MCU) in the same seatbox.
3. Receiver MCU receives and L2 frame and disable all high power power data objects (PDOs), only 4.5 W PDO remains.
4. MCU in seatbox waits 5 ms.
   1. Logic turnaround time in each MCU should be less than 1 ms. Network propagation delay of L2 frame should be 1-2 ms within SEATBOX.
5. MCU in SEATBOX assumes the DC shutdown has completed. It increases the AC current limit to 150 W.
   1. If DC shutdown failed, the 2nd stage power limit in Section 4.4 would trigger after new AC limit is set.
6. MCU in SEATBOX continues to poll the PMON circuit in a loop for future Ramp-down event if the conditions are met.
7. USB power budget is updated.
8. USB port power can be rebalanced using the updated budget.

4.2.4 Unplug Case. When a passenger detached an AC PED, the following occurs:
1. The AC inverter is disabled and the AC power budget returns to 0 W.
2. USB power budget is updated.
3. USB port power can be rebalanced using the updated budget.

### 4.3. Prerequisite for Successful 1st Stage AC/DC Balancing

1. There is at least 150 w+power loss available for seat configuration.
2. Hardware should have sufficient AC hold up power for ramp up use case to support balancing between AC and DC activities documented below. For example, power may be available at least for 100 msec.
   1. Detecting ramp up by SEATBOX MCU.
   2. Sending broadcast event by SEATBOX MCU,
   3. Detecting broadcast event by remote MCU.
   4. Set 4.5 w for all USB ports by remote MCU.

### 4.4. 2nd Stage Static Power Limit (PL)—Hardware Based Trigger (“295 W PL”)

1. This is a hardware only detection/action circuit.
2. A hard coded value is set in hardware as a trigger point for this circuit so that it would trigger before the 3rd Stage power supply shutdown (“300 W PL”)
3. When 2nd stage power limit is triggered, the hardware will disable the AC output relay
   1. AC load will be removed from the inverter.
   2. The AC inverter will remain in idle mode with several watts of static dissipation.
4. The hardware trigger should be sent to SOM.

In some embodiments, the hardware circuit is resettable by software.

Alternative 1 will be the traditional method of dedicated AC DC pool separately.

Alternative 2 will be a design where customer needs to manually select which port to use so the power pool can be directed to the port (AC or DC) that got specified.

As AC and DC are sharing the same pool, the reduced power supply size and weight substantially reduces the initial costs of line replacement units (LRUs). It also reduces operation cost of airplane fuel as well.

The seamless monitoring and transition between AC and DC pool does not require customer operation, providing a smoother customer experience.

### 5. Some Additional Embodiments

To intelligently share limited seatback(S) power with all passengers in the seat group by providing passengers with charging for high power devices (laptops, tablets, phones, etc.) using a standard USB Type C cable. By utilizing USB Type C, the passenger's need for 110 VAC charging on the aircraft is greatly reduced.

### 6. Example Hardware

6.1 Peripheral Bar USB (Type C+Type C) and USB remote jack module (RJM)(Type C+Type C) each PED port(type C) can support up to 100 W

The power jack can support up to 104.5 W combined for both Type C ports Type C port will provide up to 4.5 W for all non-PD devices

USB Type A to Type C adapter cables Type C devices that do not support PD

6.2 Some embodiments include Peripheral Bar USB (Type A+Type C) and USB RJM (Type A+Type C)

Type A will not support BC 1.2 or fast charging Type A will provide up to 4.5 W

### 6.3 Supports USB Spec 3.0

Supports USB PD Spec 3.0

Supported power range by voltage level:
5V@0.9 A (4.5 W) for
PD power negotiation
USB Type A devices (using Type C adapter) Non-PD USB Type C devices
5V@3 A (15 W)
9V@3 A (27 W)
15V@3 A (45 W)
20V@5 A (100 W)

### 7. High Level Design Examples

7.1 All power balancing software runs on the primary SOM that controls all 28 VDC power (JxA/JxB port level)
on/off control
28 VDC level faults over-current protection (OCP), SCP (short circuit protection), UVP (under voltage protection), etc.

Primary SOM communicates with the USB power jack MCUs (microcontroller units)

7.2 Power supply provides ˜300 W

Power is shared between:
IFEC hardware: monitors, peripheral bars, handsets, etc. PED charging: peripheral bar USB and USB RJM
Monitor/peripheral bar USB ports share the same 28 VDC port,
   i.e., monitor power is added to the dynamic power allocation for USB charging: J4A power=static monitor power+sum of dynamic USB power+cable loss of monitor+sum of cable loss for each USB port based on current allocated power

### 7.3 USB Power Jacks

Peripheral bar USB (type C+type C) Future Peripheral bar USB (type A+type C) USB RJM (type C+type C)

Future USB RJM (type A+type C)

All support up to 104.5 W combined PED port power,

### i.e. 100 W+4.5 W.

Each power jack has an MCU which is accessible on the internal seatback network using a Unified Messaging Bus (UMB) interface.

7.4 The MCU controls an PD controller to

enable/disable individual PED ports (type A/type C) set advertisement power level.

PD controller builds a list of PDOs up to the advertisement power level (source capabilities) i.e. 67 W 5V@3 A, 9V@3 A, 15V@3 A, 20V@3.35 A
set max allocated power level
max advertisement level the PD controller can accept sets internal OCP (overcurrent protection) power limit
receive power request events
PD controller sends events when a PED request one of the source capability profiles (PDOs)

### 8. Some Embodiment Parameters

The Seat Box has at least 215 W of power available for USB charging (and ˜300 W total for both IFEC and USB charging) minimum for guaranteed power: 3 seats*(67 W charging PED+4.5 W unused port)=3*(71.5 W)=214.5 W
If there are 2 USB jacks per seat, the minimum guaranteed power would be (67 W+4.5 W)+(4.5 W+4.5 W)=80.5 W of power per seat
a 3 seat configuration with 2 USB jacks would require a minimum USB power pool of 3*80.5 W=241.5 W There are 1, 2, or 3 seats Seat Box

There are 1 or 2 USB ports per seat (USB type-A or type-C) Each seat is guaranteed 67/71.5 W of power

Each seat can provide up to 104.5 W if there is available power The standard configuration will provide up to 67 W per port

One configuration will provide up to 100 W per port each powered on port will be provided at least 4.5 W

USB type-A ports will be treated as non-PD ports and only 4.5 W will be provided (PED attached or not attached) USB type-C to A cables will also be treated as non-PD devices which only supports 4.5 W

When balancing power and more than one port is used in a seat:

The power to the “newest” devices gets reduced to the lowest power the PED is capable of (via sink caps) the “oldest” devices gets priority.

If the power cannot be rebalanced, the power provided to the “newest” devices is reduced to 4.5 W and a notification is provided to the passenger.

### 8.1 States to Control DC Power

In some embodiments, all hardware signals (e.g., AC_Low, USB_PD_ENABLE) will disable the PD controller from providing power via a USB port to a passenger (i.e., no charging or data devices while in this condition). Alternatively, a subset of the hardware signals may be used for resetting.

In some examples, MCU provides an UMB topic event to indicate the PD controller is disabled for any reason. In some examples, the PED port is used for providing the enable/disable event.

MCU sends layer 2 Ethernet message to all USB RJM which will immediately limit the power provided to the passenger via the USB port to 4.5 W.

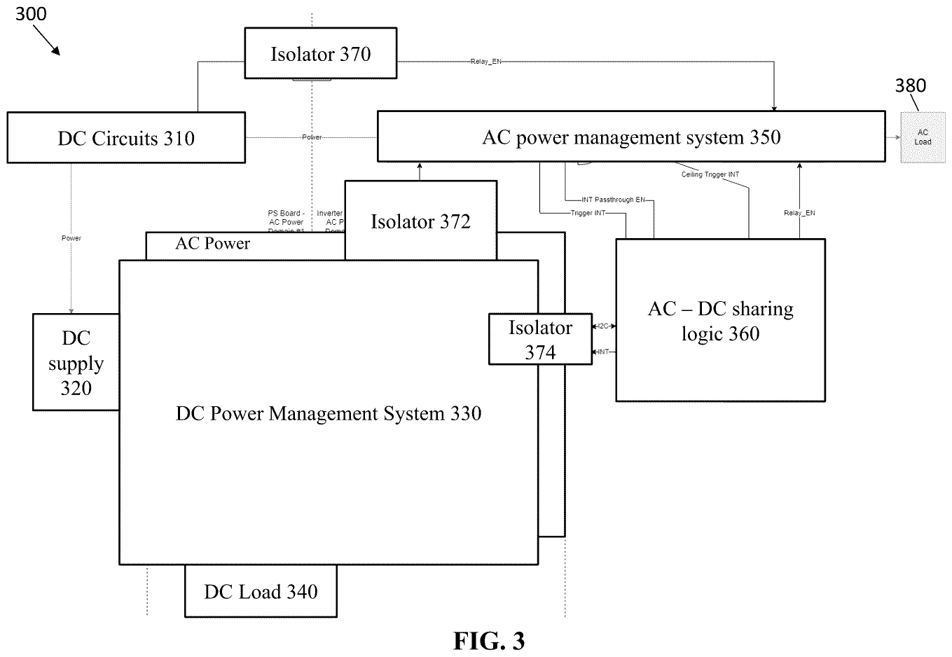

FIG. 3 shows a block diagram of an example of a power balancing system 300. Various isolators 370, 372, and 374 are provided to isolate electrical transients among various electronic systems. Depicted functional blocks may be implemented using a combination of hardware and software. DC power management system 330 may control distribution of power from DC supply 320 to DC load 340 (e.g., USB outlets). AC power management system 350 may control power supplied to AC load 380 (e.g., AC power outlets). AC-DC power sharing logic 360 may be used to balance power provided to AC and DC such that the fluctuation in load on the power supply is minimized. DC circuits 310 may monitor the DC power provided by the DC supply 320 and the AC power provided to the AC load 380. In addition, or alternatively, DC circuits 310 may disable the DC power supplied by DC supply 320 to DC load 340 and/or the AC power supplied to the AC load 380 upon detecting a power trigger point.

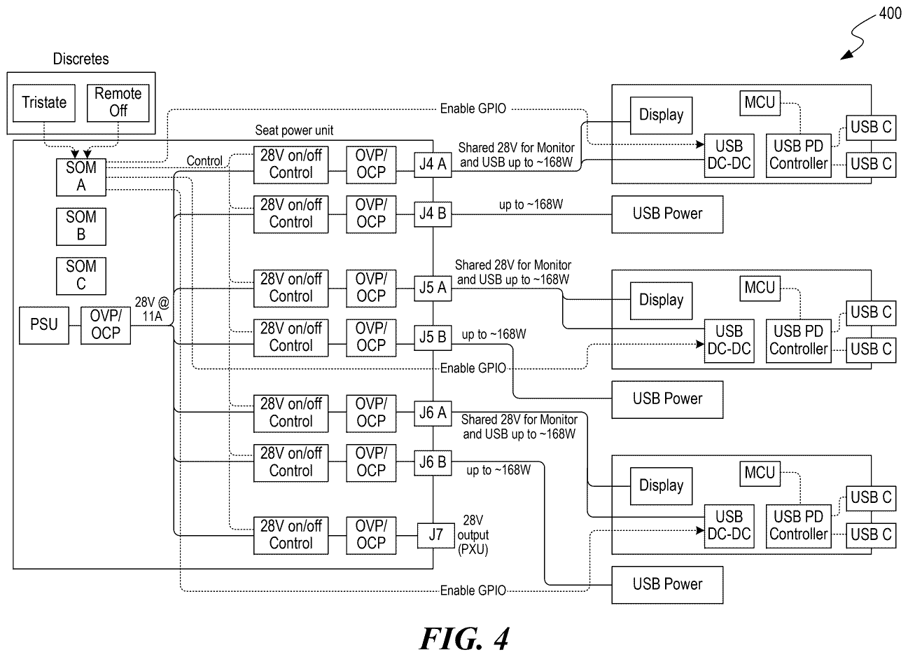

FIG. 4 is a block diagram 400 showing an example implementation of USB power sharing, as is described in Sections 6 and 7 of the present document. The depicted example show power being supplied to three seatbacks and monitors.

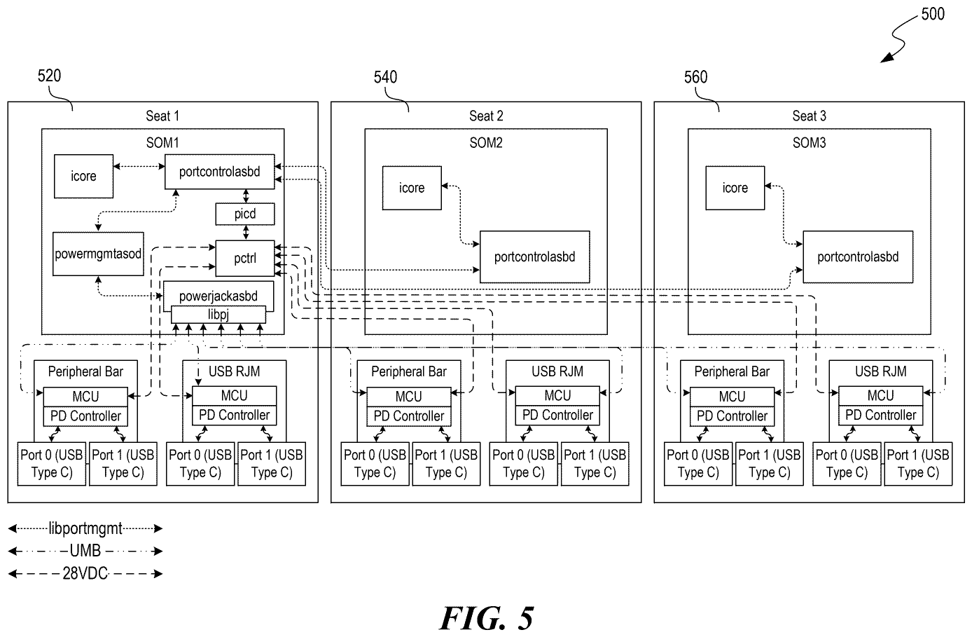

FIG. 5 is a hardware schematic of an example of power supply circuitry 500 to three seats 520, 540, 560 in a seat row as described in Sections 6-8.

### 9. Various Technical Solutions

Some preferred embodiments may implement may the following solutions.
1. A power supply system (e.g., system 700 depicted in FIG. 7), comprising: N alternating current (AC) power outlets (704) configured to provide AC power output at a passenger seat in an airplane; M direct current (DC) power outlets (706) configured to provide DC power output at the passenger seat; a controller (702) configured to control allocation of power from a power supply to the N AC power outlets and M DC power outlet according to a phase of K phases of operation of the power supply system, where K, N and M are positive integers and K is greater than 1. Various examples of the power supply system are disclosed throughout the present document, e.g., Sections 4 to 8. In some embodiments, the controller may be located within the seatbox that is affixed to a passenger seat of another passenger (e.g., a passenger in front). In some embodiment, the controller may be configured to control power outlets for multiple passenger seats such as seats in a same row.
2. The power supply system solution 1, wherein the K phases of operation comprise two or more of: a plug-in phase in which a device is plugged into one of the N AC power outlets, a ramp-down phase in which there is a reduction in a power load being consumed by a device plugged into one of the AC power outlets; a ramp-up phase in which in which there is an increase in a power load being consumed by a device plugged into one of the AC power outlets, or an unplug case in which aa device is unplugged from one of the N AC power outlets. In some embodiments, at least three of these phased may be implemented various timing constraints associated with these phases are disclosed throughout the present document, including Sections 4 to 8.
3. The power supply system of any of solutions 1-2, wherein the controller is configured to control the allocation such that a maximum instantaneous power drawn from the power supply is maintained to be less than a maximum power that can be supplied to the N AC power outlets plus a maximum power that can be supplied to the M DC power outlets.
4. The power supply system of any of solutions 1-3, wherein the controller is configured to perform a digital data exchange with the M DC power outlets to negotiate power required by devices plugged to the M DC power outlets. The negotiations may be performed using, e.g., power related message exchanges natively supported by the power interfaces (e.g., USB interface) and/or additional messaging between the power outlets and the controller.
5. The power supply system of any of above solutions, wherein the M DC power outlets comply to a universal serial bus (USB) protocol, including at least one of USB-C or USB-A protocol.
6. The power supply system of any of above solutions, wherein N=1 and M=1, 2 or 3.
7. The power supply system of solution 6, wherein a value of M depends on a passenger class in which the passenger seat is located in the airplane. For example, a greater number of M DC power outlets may be made available to a premium class seat compared to an economy class seat. As another example, although same hardware that shows a same number of power outlets to an external viewer, fewer outlets may be provided with active power in the economy class compared to the premium class. In other words, the number M may be related to a number of hardware ports, or may represent a number of actual power ports, which may be smaller than or equal to the number of hardware ports.
8. The power supply system of any of solutions 1-7, wherein the controller is configured to control allocation power from the power supply as a function of time such that power allocated to the N AC power outlets is balanced with power allocated to the M DC power outlets in a manner that minimizes fluctuations of power drawn from the power supply. One benefit of such an approach is to improve overall efficiency of the power consumption by the passenger power system in the airplane. For example, by avoiding fluctuating power use, the power system hardware may be designed with more economical tolerances for supporting spikes or peaks in power supply carriage. As another example, failures of hardware or software at certain seats could be isolated such that the failure will not affect instantaneous values of power being carried by the passenger power system.
9. The power supply system of any of solutions 1-8, further including: an electronic circuit that is configured to detect amount of power used by one or more of the N AC power outlets or M DC power outlets. In some embodiments, the power usage data may be collected and stored in an onboard database. The usage data may be used to improve reliability of future power circuitry based on power usage profile as a function of passenger demand.
10. The power supply system of solution 9, wherein the electronic circuit is further configured to disable power supplied to one or more of the N AC power outlets or M DC power outlets upon detecting a power trigger point. This feature may be used to smoothen out power spikes causes due to excessive power demand or hardware failure.
11. A method of operating power supply in an airplane (e.g., as depicted in flowchart 600 of FIG. 6), comprising: configuring (610) N alternating current (AC) power outlets to provide AC power output at a passenger seat in an airplane; configuring (620) M direct current (DC) power outlets to provide DC power output at the passenger seat; and controlling (630), using a controller, allocation of power from a power supply to the N AC power outlets and M DC power outlet according to a phase of K phases of operation of the power supply system, where K, N and M are positive integers and K is greater than 1. The controller may be as disclosed with reference to FIG. 7. Various other functional features of the controller are disclosed throughout the present document, e.g., Section s4 to 8.
12. The method of solution 11, wherein the K phases of operation comprise two or more of:
a plug-in phase in which a device is plugged into one of the N AC power outlets,
a ramp-down phase in which there is a reduction in a power load being consumed by a device plugged into one of the AC power outlets;
a ramp-up phase in which in which there is an increase in a power load being consumed by a device plugged into one of the AC power outlets, or
an unplug case in which aa device is unplugged from one of the N AC power outlets.
13. The method of any of solutions 11-12, further including
controlling the allocation such that a maximum instantaneous power drawn from the power supply is maintained to be less than a maximum power that can be supplied to the N AC power outlets plus a maximum power that can be supplied to the M DC power outlets.
14. The method of any of solutions 11-13, wherein the controller is configured to perform a digital data exchange with the M DC power outlets to negotiate power required by devices plugged to the M DC power outlets.
15. The method of any of above solutions, wherein the M DC power outlets comply to a universal serial bus (USB) protocol, including at least one of USB-C or USB-A protocol.
16. The method of any of above solutions, wherein N=1 and M=1, 2 or 3.
17. The method of solution 16, wherein a value of M depends on a passenger class in which the passenger seat is located in the airplane.
18. The method of any of solutions 11-17, wherein the controller is configured to control allocation power from the power supply as a function of time such that power allocated to the N AC power outlets is balanced with power allocated to the M DC power outlets in a manner that minimizes fluctuations of power drawn from the power supply.
19. The method of any of solutions 11-18, further including:
detecting, using an electronic circuit an amount of power used by one or more of the N AC power outlets or M DC power outlets.
20. The method of solution 19, including:
disabling power supplied to one or more of the N AC power outlets or M DC power outlets upon detecting a power trigger point.

The preferred solutions therefore provide for a power load balancing between AC power outlets and DC power outlets at a passenger seat. These outlets may be located on the seatback, in handrest or near the seat such that the user can plug a wire into the outlet or use remote power charging capability of the outlet to power a PED. It will be further appreciated that the power load balancing may allocate a certain power budget to AC and DC outlets depending on the situation it senses from the attached PEDs instantaneous power demand.

### 10. Conclusion

It will be appreciated by those of skill in the art that the present document provides techniques that reduce the maximum power capacity of an airplane while providing adequate power to seatback power outlets. Using the disclosed techniques, a passenger may experience high quality of service because, during each phase of operation of the power system, the passenger experiences adequate power being provided to the AC or DC power outlet. At the same time, by performing power balancing between AC and DC outlets, the total amount of power output of the main power supply that powers seatback outlets can be reduced, which results in improved airplane operation efficiency.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A power supply system, comprising:
N alternating current (AC) power outlets configured to provide AC power output at a passenger seat in an airplane;
M direct current (DC) power outlets configured to provide DC power output at the passenger seat;
a controller configured to control allocation of power from a power supply to the N AC power outlets and M DC power outlet according to a phase of K phases of operation of the power supply system, where K, N and M are positive integers and K is greater than 1.

2. The power supply system of claim 1, wherein the K phases of operation comprise two or more of:
a plug-in phase in which a device is plugged into one of the N AC power outlets,
a ramp-down phase in which there is a reduction in a power load being consumed by a device plugged into one of the AC power outlets;
a ramp-up phase in which in which there is an increase in a power load being consumed by a device plugged into one of the AC power outlets, or
an unplug case in which aa device is unplugged from one of the N AC power outlets.

3. The power supply system of claim 1, wherein the controller is configured to control the allocation such that a maximum instantaneous power drawn from the power supply is maintained to be less than a maximum power that can be supplied to the N AC power outlets plus a maximum power that can be supplied to the M DC power outlets.

4. The power supply system of claim 1, wherein the controller is configured to perform a digital data exchange with the M DC power outlets to negotiate power required by devices plugged to the M DC power outlets.

5. The power supply system of claim 1, wherein the M DC power outlets comply to a universal serial bus (USB) protocol, including at least one of USB-C or USB-A protocol.

6. The power supply system of claim 1, wherein N=1 and M=1, 2 or 3.

7. The power supply system of claim 6, wherein a value of M depends on a passenger class in which the passenger seat is located in the airplane.

8. The power supply system of claim 1, wherein the controller is configured to control allocation power from the power supply as a function of time such that power allocated to the N AC power outlets is balanced with power allocated to the M DC power outlets in a manner that minimizes fluctuations of power drawn from the power supply.

9. The power supply system of claim 1, further including:
an electronic circuit that is configured to detect amount of power used by one or more of the N AC power outlets or M DC power outlets.

10. The power supply system of claim 9, wherein the electronic circuit is further configured to disable power supplied to one or more of the N AC power outlets or M DC power outlets upon detecting a power trigger point.

11. A method of operating a power supply system in an airplane, comprising:
configuring N alternating current (AC) power outlets to provide AC power output at a passenger seat in an airplane;
configuring M direct current (DC) power outlets to provide DC power output at the passenger seat;
controlling, using a controller, allocation of power from a power supply to the N AC power outlets and M DC power outlet according to a phase of K phases of operation of the power supply system, where K, N and M are positive integers and K is greater than 1.

12. The method of claim 11, wherein the K phases of operation comprise two or more of:
a plug-in phase in which a device is plugged into one of the N AC power outlets,
a ramp-down phase in which there is a reduction in a power load being consumed by a device plugged into one of the AC power outlets;
a ramp-up phase in which in which there is an increase in a power load being consumed by a device plugged into one of the AC power outlets, or
an unplug case in which aa device is unplugged from one of the N AC power outlets.

13. The method of claim 11, further including
controlling the allocation such that a maximum instantaneous power drawn from the power supply is maintained to be less than a maximum power that can be supplied to the N AC power outlets plus a maximum power that can be supplied to the M DC power outlets.

14. The method of claim 11, wherein the controller is configured to perform a digital data exchange with the M DC power outlets to negotiate power required by devices plugged to the M DC power outlets.

15. The method of claim 11, wherein the M DC power outlets comply to a universal serial bus (USB) protocol, including at least one of USB-C or USB-A protocol.

16. The method of claim 11, wherein N=1 and M=1, 2 or 3.

17. The method of claim 16, wherein a value of M depends on a passenger class in which the passenger seat is located in the airplane.

18. The method of claim 11, wherein the controller is configured to control allocation power from the power supply as a function of time such that power allocated to the N AC power outlets is balanced with power allocated to the M DC power outlets in a manner that minimizes fluctuations of power drawn from the power supply.

19. The method of claim 11, further including:
detecting, using an electronic circuit an amount of power used by one or more of the N AC power outlets or M DC power outlets.

20. The method of claim 19, including:
disabling power supplied to one or more of the N AC power outlets or M DC power outlets upon detecting a power trigger point.
